(19) United States
(12) Patent Application Publication
(10) Pub. No.: US 2022/0413931 A1
(43) Pub. Date: Dec. 29, 2022

(54) INTELLIGENT RESOURCE MANAGEMENT

(71) Applicant: QUANTA CLOUD TECHNOLOGY INC., Taipei City (TW)

(72) Inventors: Tsung Hung CHIANG, Taipei City (TW); Pa HSUAN, Taipei City (TW); Chia Jui LEE, Taipei City (TW)

(21) Appl. No.: 17/304,589

(22) Filed: Jun. 23, 2021

(51) Int. Cl. G06F 9/50; G06N 20/00

(52) U.S. Cl. CPC G06F 9/5072; G06F 9/5044; G06N 20/00

(57) ABSTRACT

A system and method for distributing resources in a computing system is disclosed. The resources include hardware components in a hardware pool, a management infrastructure, and an application. A telemetry system is coupled to the resources to collect operational data from the operation of the resources. A data analytics system is coupled to the telemetry subsystem to predict a future operational data value based on the collected operational data. A policy engine is coupled to the data analytics system to determine a configuration to allocate the resources based on the future operational data value.

### TECHNICAL FIELD

The present disclosure relates generally to resource management for computing devices. More particularly, aspects of this disclosure relate to a system that provides an intelligent mechanism for managing resources across multiple servers.

### BACKGROUND

Servers are employed in large numbers for high demand applications, such as network based systems or data centers. The emergence of the cloud for computing applications has increased the demand for data centers. Data centers have numerous servers that store data and run applications accessed by remotely connected, computer device users. A typical data center has physical chassis rack structures with attendant power and communication connections. Each rack may hold multiple computing servers and storage servers that are networked together.

The servers in a data center facilitate many services for businesses, including executing applications, providing virtualization services, and facilitating Internet commerce. Servers typically have a baseboard management controller (BMC) that manages internal operations and handles network communications with a central management station in a data center. Different networks may be used for exchanging data between servers and exchanging operational data on the operational status of the server through a management network.

Data center management is an important but complex job for daily operations. In traditional data center management methods, administrators arrange the hardware devices such as servers for a specific workload purpose. Urgent service requirements usually make the efficient scheduling and allocation of workloads difficult to be implemented. Thus, traditional data center management methods always allocate the maximum resources for peak service requirements. However, in this case, the resource utilization rate is always low because of idle resources during non-peak times and the data center fails to effectively utilize resources. Other use cases involving different resource utilization rates also result in low resource utilization rate. For example, in a 5G communication system the resource utilization in a city area and a residential area are supposed to be different. In a city area, the resource utilization in working hours is always high, which is a different situation from that of in residential area. Moreover, in a commercial area, the resource preparation is designed specifically for working hours for to facilitate user needs while for non-working hours, the resources are usually idle in the commercial area.

Service capacity can be easily scaled in or out using an intelligent engine according to current CPU networking or memory usage. With an intelligent engine, the management software (e.g., the Kubernetes and OpenStack platform) has been used to monitor the environment and automatically control the service scale. For some stateful services, launching a new service entity is time-consuming. Further, such new service entities may not be prepared to accept requests from a client immediately. For some connection-oriented services, such as gaming, VPN, and 5G connections, frequent scaling in and scaling out of services leads to the difficulty of implementing session management and decreases the quality of service. This results in service reconnection and service handover when the service is scaled in. When service is scaled out, newly-added services can be executed in a new computing system (usually a virtual machine (VM), container, or bare metal system). For scaling in, the services are gathered together to free computing system resources (usually a VM, a container, or a bare metal system). For example, a system may have three resource computing systems. When the third computing system needs to be freed up, the service running on the third computing system resource should be migrated to the other two computing system resources. The concurrent jobs on the third computing system resource will therefore encounter service/job handover issues causing reconnection. Often, data center customers will have service requests that require an increase in computing resources. In order to fulfill urgent service requirements from the customer side, automation of resource allocation is considered to be a focal feature in daily operation of servers in a data center.

Thus, there is a need for a system that allows data centers to dynamically change resource allocation to hardware in real time. There is a need for a system that allows pre-allocation of resources based on historical record, predict future requirements, and train a model to fulfill the pattern from the monitored data. There is also a need for a system that employs a policy engine that determines proper configurations based on at least one model for resource allocation in a computer system.

### SUMMARY

One disclosed example is a system for distributing resources in a computing system. The resources include hardware components in a hardware pool, a management infrastructure, and an application. A telemetry system is coupled to the resources to collect operational data from the operation of the resources. A data analytics system is coupled to the telemetry subsystem to predict a future operational data value based on the collected operational data. A policy engine is coupled to the data analytics system to determine a configuration change action for the allocation of the resources in response to the predicted future operational data value.

A further implementation of the example system is an embodiment where the data analytics system determines the future operational data value based on a machine learning system. The operational data collected by the telemetry subsystem trains the machine learning system. Another implementation is where the machine learning system produces multiple models. Each of the multiple models predict a different scenario of the future operational data value. Another implementation is where the data analytics system selects one of the multiple models to determine the resource allocation. Another implementation is where the policy engine includes a template to translate the predicted future operational data value from the data analytics system into the resource allocation. Another implementation is where the configurations include a hardware management interface for the hardware component, a management API for the infrastructure and an application API for the application. Another implementation is where the hardware component is one of a group of processors, management controllers, storage devices, and network interface cards. Another implementation is where the resources are directed toward the execution of the application. Another implementation is where hardware components are deployed in computer servers organized in racks. Another implementation is where the future operational data value is a computational requirement at a predetermined time.

Another disclosed example is a method of allocating resources in a computing system. The resources include at least one of a hardware component, a management infrastructure, or an application. Operational data is collected from the operation of the resources via a telemetry system. A future operational data value is predicted based on the collected operational data via a data analytics system. A configuration to allocate the resources is determined in response to the predicted future operational data value.

Another implementation of the example method includes training a machine learning system from the collected data. The data analytics system determines the future operational data value from the machine learning system. Another implementation is where the method includes producing multiple models from the machine learning system. Each of the multiple models predict a different scenario of the future operational data value. Another implementation is where the data analytics system selects one of the multiple models to determine the resource allocation. Another implementation is where the policy engine includes a template to translate the predicted future operational data value from the data analytics system into the resource allocation. Another implementation is where the configurations include a hardware management interface for the hardware component, a management API for the infrastructure, and an application API for the application. Another implementation is where the hardware component is one of a group of processors, management controllers, storage devices, and network interface cards. Another implementation is where the resources are directed toward the execution of the application. Another implementation is where the hardware components are deployed in computer servers organized in racks. Another implementation is where the future operational data value is a computational requirement at a predetermined time.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a block diagram of a computing system that includes diverse hardware resources;

FIG. 2 is a block diagram of the components of the intelligent resource system;

FIG. 3A is a block diagram of an example OSP architecture for the NFV component of the resource system in FIG. 1;

FIG. 3B is a block diagram of an example OCP architecture for the NFV component of the resource system in FIG. 1;

FIG. 4 is a detailed block diagram of certain of the components of the intelligent resource system in FIG. 2;

FIG. 5 is an image of an interface generated by the telemetry system in FIG. 4;

FIG. 6A is a block diagram of an example analytics module;

FIG. 6B is a process flow diagram of the orchestration to assign hardware resources in the computing system;

FIG. 7 is an example table for generating a rule engine;

FIG. 8 is a flow diagram of the process to assign hardware resources in a computing system; and

FIGS. 9-10 are block diagrams of example computer systems to implement the example processes described herein.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The examples disclosed herein include a system and method to allow a data center to dynamically change the hardware resource allocation to an infrastructure service (when resources are insufficient) or a virtualized resource to applications (when the resources are) in real time. The intelligent resource management system can be adopted to pre-allocate hardware resources based on the historical record of an operational data value such as bandwidth required, predict future requirements, and train a model to fulfill the pattern from the monitored data. The mechanism implements reactive scaling with low response time to expand the service capacity, and the service can be properly configured to avoid bursts of requests from servers. The reactive scaling is performed based on predictions according to analysis of historical data of operational data of the system. The current data is mapped and the future operational data value is predicted to implement the scaling process. For example, a subsequent 10-minute resource utilization need may be predicted, and the resources may be pre-allocated for future consumption for that period of time. The service scale can be proactively expanded or shrunk in relation to the available resources. At the same time, only necessary resources are allocated to run services on the servers. The energy consumption of the managed servers also become more efficient based on the intelligent resource allocation as hardware resources are more efficiently deployed or deactivated as needed.

FIG. 1 shows a computer system 100 that includes computer resources that are networked. The computer system 100 includes a series of racks 110a-110n. Each of the racks 110a-110n includes a management switch 120 and a series of data switches 122. As shown in this example, the switches 120 and 122 are installed in the top slots of a rack. The rest of the slots in the rack hold servers 130 and other hardware resources. In this example, certain servers are example application servers, and certain servers are storage servers. The servers 130 can include storage servers 132a-132n and application servers 134a-134n. Different cables (not shown for clarity) connect the switches 120 and 122 to the servers 130. Other hardware resources such as a just a bunch of disks (JBOD) device or an acceleration card chassis may constitute hardware resources of the system 100.

A remote management station 140 is coupled to a management network 142. The remote management station runs management applications to monitor and control the servers 130 through the management network 142. A data network 144 that is managed through the switches 120 allows the exchange of data between the servers 130 in a rack, such as the rack 110a, and the servers in other racks.

The servers 130 each include a baseboard management controller (BMC). The BMC includes a network interface card or network interface controller that is coupled to the management network 142. The servers 130 all include hardware components that may perform functions such as storage, computing, and switching. For example, the hardware components may be processors, memory devices, PCIe device slots, etc. The BMC in this example monitors the hardware components in the respective server and allows collection of operational and usage data through the management network 142.

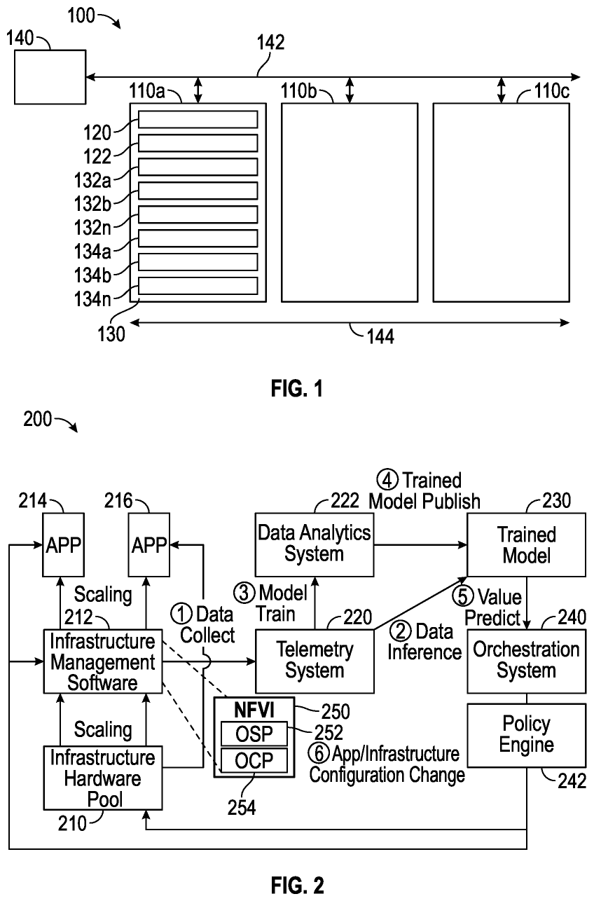

FIG. 2 shows a system architecture of a resource distribution system 200 that allows intelligent distribution of hardware resources in the computer system 100. The architecture of the resource distribution system 200 includes an infrastructure hardware pool 210, infrastructure management software 212, and applications 214 and 216. The infrastructure management software 212 in this example may be executed by the remote management station 140 in FIG. 1 or other computing resources accessible to a data center administrator. A container deployment and management platform such as K8s/OpenStack is executed by the remote management station 140. When the resources allocated in the K8s/OpenStack platform are not sufficient, new hardware computing resources will be allocated to deploy K8s/OpenStack components, in which the new resources are joined to the existing K8s/OpenStack platform. For example, in K8s, software components are installed either for building a worker node or in the master node. Alternatively, or in additionally, existing resources may be reallocated to join the existing K8s/OpenStack platform. In this example, freed up resources are returned to the resource pool that may be made available for future allocations. Thus, the services are deployed in the new computing system (the deployed K8s/OpenStack), which may be a physical server or a virtual machine. In contrast, when the resources in the K8s/OpenStack are sufficient, the applications will be immediately scaled out, constituting a scale out of the resources. In the K8s/OpenStack platform, services on the application that are freed up are handed over to the rest of the applications and the resources are returned to the K8s/OpenStack platform. This constitutes a scale out of the resources. When the application is no longer executed in the computing system, the management software checks if any applications are executing in the computing system. When there are no applications executing, the hardware computing system is removed from the cluster and the resources are returned to the hardware pool. This constitutes a scale in of the resources.

The applications 214 and 216 may be applications such as eMarket or a 5G traffic forwarding system that are deployed on the K8s/OpenStack platform on servers such as the application servers 134a-134n (FIG. 1) in accordance with user demand. The hardware pool 210 includes all network hardware in the system 100 such as the servers 130, storage devices, switches such as the switches 120 and 122, and acceleration card chassis units (e.g., FPGA, GPU, smart NIC). The infrastructure hardware pool 210 categorizes different hardware types to the hardware pool. For example, the hardware in the hardware pool 210 can be categorized according to same SKU server, the same SKU storage, and the same category acceleration card.

A telemetry system 220 is coupled to a data analytics system 222. The data analytics system 222 produces a trained model 230 based on operational data collected by the telemetry system 220 in relation to hardware resource allocation in the computer system 100. Examples of operational data include throughput, packet count, session count values, and latency. Error count data in the form of discarded packets, over lengthy packets, and error packets may also be operational data. The trained model 230 predicts a future operational data value such as the necessary processing bandwidth for the hardware resources. The trained model 230 is loaded into an orchestration system 240 that configures a policy engine 242 that allows for allocation or reallocation of resources from the infrastructure hardware pool 210 to meet the future operational data value.

The infrastructure management software 212 in this example may include Network Functions Virtualization (NFVI) infrastructure software 250 that includes network access and service execution environment routines for the hardware resources in the hardware pools 210. The NFVI infrastructure software 250 in this example includes an Open Stack Platform (OSP) architecture 252 such as an OpenStack Commercial Version architecture or an OpenShift Container Platform (OCP) architecture 254 such as the K8s Enterprise Version. The NFVI infrastructure software 250 is a platform the partition the hardware and software layers. The hardware resources may include a server, a virtual machine (VM), a container, or an application for each of the architectures.

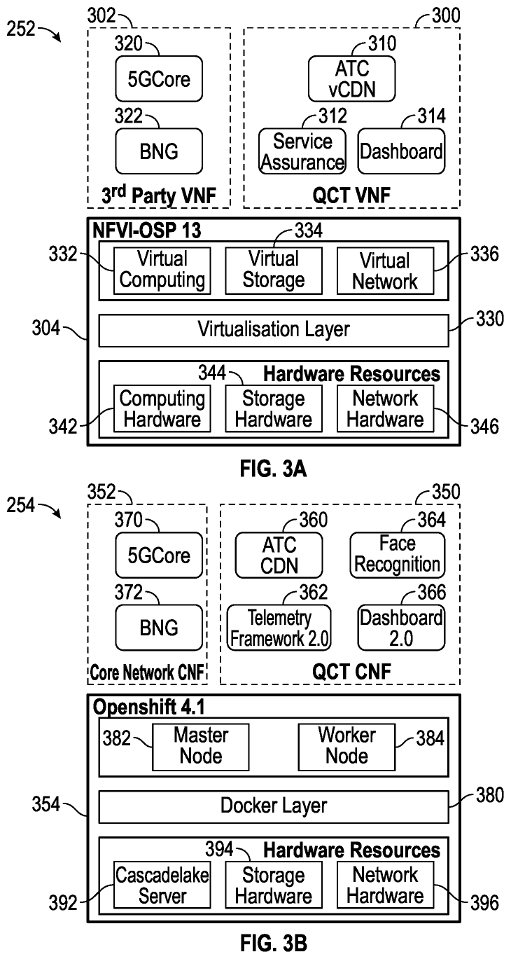

FIG. 3A shows the example OSP architecture 252 in the NFVI software 250 in FIG. 2. The architecture 252 includes a set of virtual network functions 300 from an in-house developer and a set of network functions 302 from third parties. The architecture 252 includes a set of resources 304 for NFVI OSP13 in this example. The virtual network functions 300 include traffic control virtualized content delivery network software 310, a service assurance software 312, and dashboard software 314. In this example, the traffic control virtualized content delivery network software is the Apache Traffic Control product from QCT, but other types of software performing the same function may be used. In this example, the network functions 302 from the third party include a 5G Core software 320 for facilitating 5G communications and broadband network gateway (BNG) software 322 for facilitating broadband communication. Of course other virtual network functions may be provided by software provided by third parties in addition to the example software 320 and 322. The resources 304 include a virtualization layer 330 that includes virtual computing resources 332 such as virtual machines, virtual storage devices 334, and a virtual network device 336. The resources 304 also include physical hardware resources including computing hardware 342, storage hardware 344, and network hardware 346. The different network functions are operated by the virtual resources in the virtualization layer 330 which in turn run on the physical hardware resources.

FIG. 3B shows the example OCP architecture 254 in the NFVI software 250 in FIG. 2. The architecture 254 includes a set of Cloud native network functions (CNF) 350 from an original equipment manufacturer and a set of core networks virtual network functions 352 from third parties. The architecture 252 also includes a container environment 354. In this example, the virtual network functions 350 include a traffic control content delivery network software 360, telemetry framework software 362, face recognition software 364, and a dashboard application 366. The virtual network functions 352 from third parties include a 5G Core software 370 for facilitating 5G communications and broadband network gateway (BNG) software 372. Other software performing other network functions may be provided from either the OEM or the third-party vendor.

The container environment 354 include a container management interface 380 that includes a master node 382 and a worker node 384. The container management interface 380 builds master and worker nodes such as the master node 382 and the worker node 384. The building of master and worker nodes is a mechanism for OpenShift to facilitate container management for computing, network and storage resources. One example is a 5G Core where registration, account management, and traffic tiering are different functions tackled by CNFs. Each of the functions is executed by one or more containers. The master node 382 performs a manger role used to manage OpenShift while the worker node 384 has the role of running and monitoring containers. The container environment 354 also include physical hardware resources including a server 392, storage hardware 394, and network hardware 396.

Returning to FIG. 2, the telemetry system 220 is used to collect the statistical data from the operation of the allocated infrastructure hardware in the hardware pools 210, infrastructure management software 212, and applications such as the applications 214 and 216, that are deployed on top of infrastructure management software 212. In this example, the applications are deployed on the servers via the K8s/OpenStack platform. The infrastructure management software 212 can access the servers, the switches, the K8s/OpenStack platform, and applications to manage them via a standard interface.

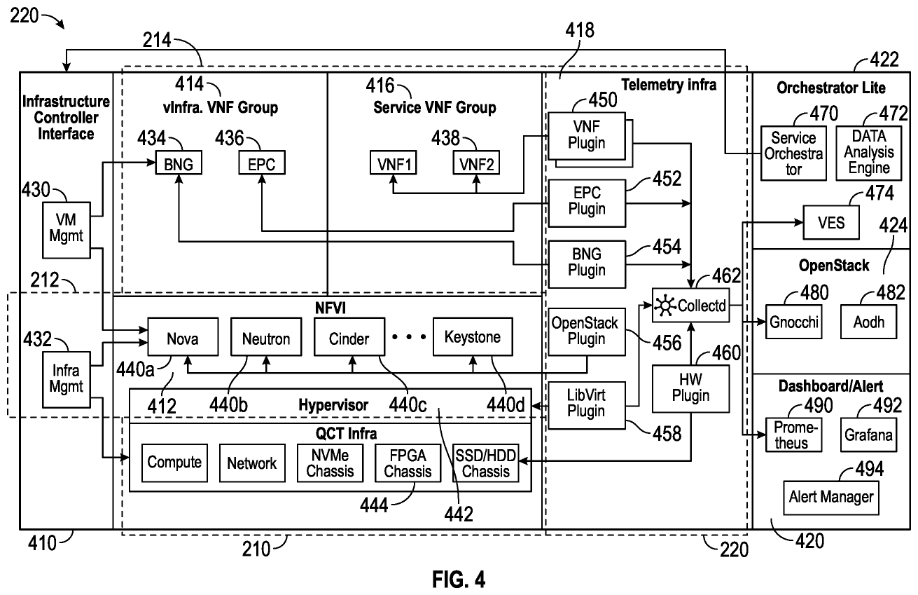

FIG. 4 shows a detailed block diagram of the subcomponents of the resource distribution system 200 in FIG. 2 including the infrastructure hardware pool 210, infrastructure management software 212, telemetry system 220, and data analytics system 222.

The infrastructure management software 212 includes components of an infrastructure controller interface 410, a network functions virtualization infrastructure (NFVI) 412. The example applications 214 and 216 in FIG. 2 include applications from a virtual network functions (VNF) group 414 and a service VNF group 416. The telemetry system 220 includes a telemetry infrastructure 418 and a dashboard/alert module 420. An orchestrator lite system 422 includes the data analytics system 222, the trained model, the orchestration system 240, and policy engine 242 in FIG. 2. An optional OpenStack module 424 may be accessed for providing real-time data and analysis specific to OpenStack usage.

The infrastructure controller interface 410 is an interface or library to manage hardware, OpenStack, K8s, and CNF/VNF that includes a virtual machine manager 430 and an infrastructure manager 432. The virtual machine manager 430 manages the virtual machines in the computer system 100 in FIG. 1. The virtual machine manager 430 is in communication with the network interfaces managed by the VNF group 412 and the OpenStack components of the NFVI infrastructure software 250. The infrastructure manager 432 is part of the infrastructure management software 212. The infrastructure manager 432 manages hardware in the infrastructure hardware pool 210, such as the servers in the computer system 100 in FIG. 1 and is in communication with the OpenStack components and the actual hardware infrastructures in the NFVI infrastructure software 250.

The VNF group 414 includes a broadband network gateway 434 and an evolved packet core 436. The broadband network gateway 434 is an application for facilitating broadband communication. The evolved packet core 436 is the core network for either 4G or LTE communication. The service VNF group 416 includes virtual network function (VNF) modules 438. The VNF modules 438 are applications implemented on the platform that are deployed based on requests by users. For example, a user may require a streaming data server and a Content Delivery Network (CDN) service to provide good user experience with low latency.

The network functions virtualization infrastructure (NFVI) 412 includes the networking hardware and software supporting and connecting virtual network functions. The NFVI 412 includes OpenStack components 440a, 440b, 440c, and 440d such as the Nova, Neutron, Cinder, and Keystone components. The NFVI 412 includes a hypervisor 442 that is coupled to hardware components 444 such as servers, switches, NVMe chassis, FPGA chassis, and SSD/HDD chassis. The hardware components 444 are part of the infrastructure hardware pool 210. The hypervisor 442 supervises virtual machine creation and operation in the hardware resources.

The telemetry infrastructure 418 generally collects operational data from the management software 212 in FIG. 2. The telemetry infrastructure 418 includes a series of plug-ins to collect operational data. The plug-ins include VNF plug-ins 450, an EPC plug-in 452, a BNG plug-in 454, an OpenStack plug-in 456, a hypervisor plug-in 458, and a hardware plug-in 460. A data interface module 462 receives data from the plug-ins. In this example, the data interface module 462 is the collected open-source software that provides uniform interface for data collector and provides multiple interfaces to send collected data to different targets. In this example, the data interface module 462 sends the collected data to the dashboard/alert module 420, which as will be explained, provides a user interface for the telemetry system 220. The data interface module 462 also sends the collected data to the orchestrator lite system 422 and the OpenStack module 424.

The VNF plug-ins 450 receives specific data, such as cache hit rates and buffered data size for a CDN application, from each of the VNF modules 438. The EPC plug-in 452 receives network traffic data from the evolved packet core 436. The BNG plug-in 454 receives broadband operational data from the broadband network gateway 434. The OpenStack plug-in 456 receives maximum virtual resource, occupied virtual resource, and running instance status data from the OpenStack components 440a-440d. In this example, the resources are components such as CPUs, memory, storage devices such as HDDs, or network interfaces. The hypervisor plug-in 458 receives operational data relating to virtual machines operated by the hypervisor 442. The hardware plug-in 460 receives operational data from the hardware components 444. Thus, the CPU may supply compute utilization data, the network interface and SSD/HHD chassis may supply port status and port utilization data, the NVMe chassis may supply NVMe status and I/O throughput, and the FPGA chassis may supply the number of used FPGAs and chip temperature.

The orchestrator lite system 422 includes a service orchestrator 470, a data analysis engine 472 and a VNF Event stream (VES) module 474. In this example, the service orchestrator 470 is composed of the orchestration system 240 and the policy engine 242 in FIG. 2. The data analysis engine 472 is a combination of the data analytics system 222 and the trained model 230 in FIG. 2. The VES module 474 coordinates model training and data inference by transferring performance matrix data for orchestration implementations such as the Open Networking Automation Platform (ONAP).

The OpenStack module 424 includes a time series database 480 such as Gnocchi and an alarming service 482 such Aodh. The time series database 480 stores time-series data such as CPU utilization. The alarming service 482 is used by the OpenStack module 424 to monitor stored data and send alerts to an administrator. A telemetry module, time series database, and alarm system may be provided for obtaining and storing real-time data, storing it and sending abnormal information to an administrator.

The dashboard/alert module 420 includes a Prometheus time series database 490, a time series metrics user interface 492 (Grafana) and an alert manager 494. The database 490 receives the time based operational data relating to the system resources from the data interface module 462. The user interface 492 allows the generation of an interface display that shows selected resource metrics. The alert manager 494 allows monitoring of metrics and alert notification.

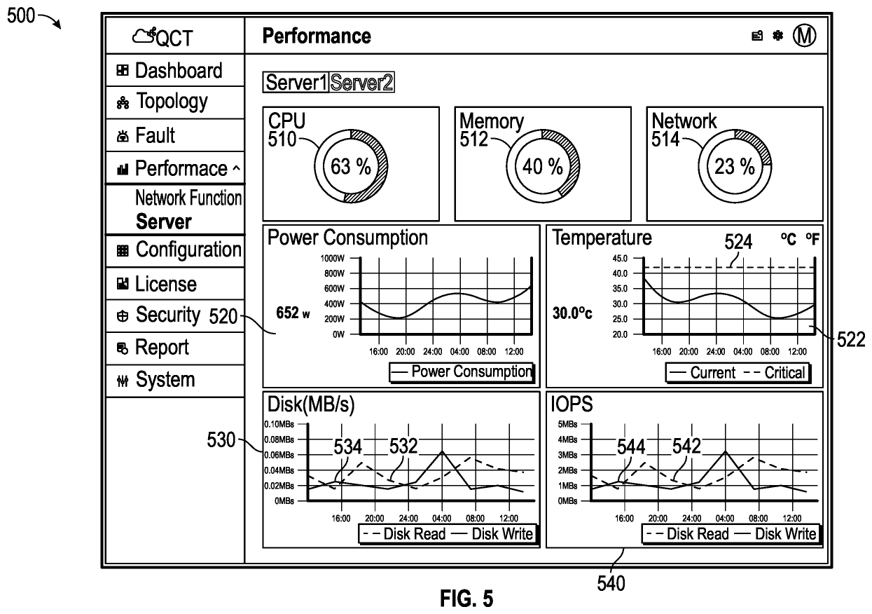

FIG. 5 shows an example interface 500 that is generated by the user interface 492 in FIG. 4. The interface 500 relates to performance data that is obtained by the telemetry system 220 from a server. The interface 500 includes a CPU utilization graphic 510, a memory utilization graphic 512, and a network utilization graphic 514. The utilization graphics 510, 512, and 514 show the percentage utilization of the CPU, memory, and network respectively. The interface 500 also shows a time based power consumption graph 520 and a time based temperature graph 522. The power consumption graph 520 shows power consumption over a 24 hour period in this example as well as the current power consumption level. The temperature graph 522 shows temperature over a 24 hour period in this example as well as the current temperature level. A disk graph 530 shows a trace 532 showing disk read rates over time and a trace 534 showing disk write rates over time. An input/output per second (IOPS) graph 540 includes a trace 542 showing disk read rates over time and a trace 544 showing disk write rates over time for storage devices. Notifications may be sent to an administrator when threshold levels are exceeding for specific metrics. For example, in relation to the temperature graph, when the temperature is high enough to exceed a threshold line 524, an alarm will be sent by either e-mail or instant message to an administrator.

Returning to FIG. 2, the data analytics system 222 may include machine learning ability to assist or analyze the collected operational data from the telemetry system 220 to predict future operational data values. For example, the data analytics system 222 may be based on a machine learning framework such as Keras or PyTorch. The machine-learning engine developed with the machine learning framework may implement machine-learning structures such as a neural network, decision tree ensemble, support vector machine, Bayesian network, or gradient boosting machine. Such structures can be configured to implement either linear or non-linear predictive models for monitoring different conditions during system operation.

For example, data processing such as a traffic prediction model developed by vendor such as Quanta Cloud Technology (QCT) of Taipei, Taiwan may be carried out by any one or more of supervised machine learning, deep learning, a convolutional neural network, and a recurrent neural network. In addition to descriptive and predictive supervised machine learning with hand-crafted features, it is possible to implement deep learning on the machine-learning engine. In addition to descriptive and predictive supervised machine learning with hand-crafted features, it is possible to implement deep learning on the machine-learning engine. This typically relies on a larger amount of scored (labeled) data (such as many hundreds of data points collected by the telemetry system 220 from the infrastructure management software 212) for normal and abnormal conditions. This approach may implement many interconnected layers of neurons to form a neural network (“deeper” than a simple neural network), such that more and more complex features are “learned” by each layer. Machine learning can use many more variables than hand-crafted features or simple decision trees.

The inputs to the machine learning network may include the collected statistics relating to operational data for resource use, and the outputs may include future prediction statistics for operational data values. The resulting trained model 230 is the published model with inferencing abilities for resource allocation across the hardware pools 210. The orchestration system 240 manages the service/infrastructure orchestration, overlay network topology, and policies for the hardware system by deploying resources from the hardware pool 210. Moreover, the orchestration system 240 receives the events from the trained model 230. The orchestration system 240 includes a policy engine 242 that determines a predefined action to deal with the predicted operational data value determined from received events. For example, if the event leads to a prediction that a service has run out of resources or will run out of resources shortly due to an application such as the applications 214 or 216 going on line, the policy engine 242 will pick up one of the predefined scale-out actions to launch a new application and configure a new network configuration to bind the application together and share the loading among the pool of hardware resources. If applications are no longer needed, the policy engine 242 picks up one of the predefined scale-in actions.

The process of preparing the orchestration system 240 includes collecting data, determining interferences from the data, training the model, publishing the model, and deploying the model. A data collector in the telemetry system 220 collects operational data such as performance metrics from hardware in the hardware pool 210, the infrastructure management software 212, and the applications 214 and 216. The performance metrics may include request counts and network packet counts. The applications check the requests sent from or to user equipment and an orchestrator is implemented, depending on how many requests needs to be processed or handled. For example, in a 5G communication system, the requests relate to how many 5G Core instances are required for scaling. The collected performance metrics are stored in the telemetry system 220. The performance metrics are sent to the trained model 230. The trained model 230 produces inferences relating to resource allocation in the future and thus outputs a predictive operational data value such as the concurrent request bandwidth or the network packet counts at a predetermined time in the future. Simultaneously, the performance metrics are sent to the data analytics system 222 for model training purposes.

In this example, the data analytics system 222 periodically publishes the latest trained model. The trained model is incrementally improved to enhance the model based on latest metrics so as to ensure increased accuracy. The trained model 230 periodically sends the predictive operational data values to the orchestration system 240 according to a pre-defined schedule. The length of the time period for a predictive value is related to the amount of data. For example, predictions of operational data values in a future ten minute period are generally more precise than the prediction of resources for a future 20 minute period. In this example, the predictions are generally sufficiently accurate within a 10-minute interval, and thus the trained model periodically (every 10 minutes) sends the predictive values. Since the data is not always in a steady status, the model 230 outputs both peak hours and idle hours in terms of resources utilization.

The data length and data size influence the accuracy of the model 230. As the data size increases, the accuracy rate is relatively high. With the same model, the accuracy rate for predicting operational data values for shorter times in the future is higher than that for predicting operational data values for longer times in the future. The peak and idle hours refer to a data pattern. The pattern is changed according to the type of data resource, such as resource management for a residential area as opposed to a commercial area. Data prediction over a small interval can also result in a more accurate prediction. For example, the data pattern on a graph may show a relatively smooth curve for 10-second interval of collected data, compared with that of the data pattern on a graph for a 5 minute interval of collected data. The accuracy rate for the 10 second data collection is relatively high as well, compared to that of for the 5 minute data collection.

After receiving the predicted future operational data value from the trained model 230, the orchestration system 240 determines configuration changes of resource allocations based on the output of the policy engine 242. The orchestration system 240 sends the resulting configuration change commands to the hardware in the hardware pools 210, infrastructure management software 212, or applications 214 and 216, to change the configuration of different hardware resources and thereby deploy the resources more efficiently according to the results of the trained model 230.

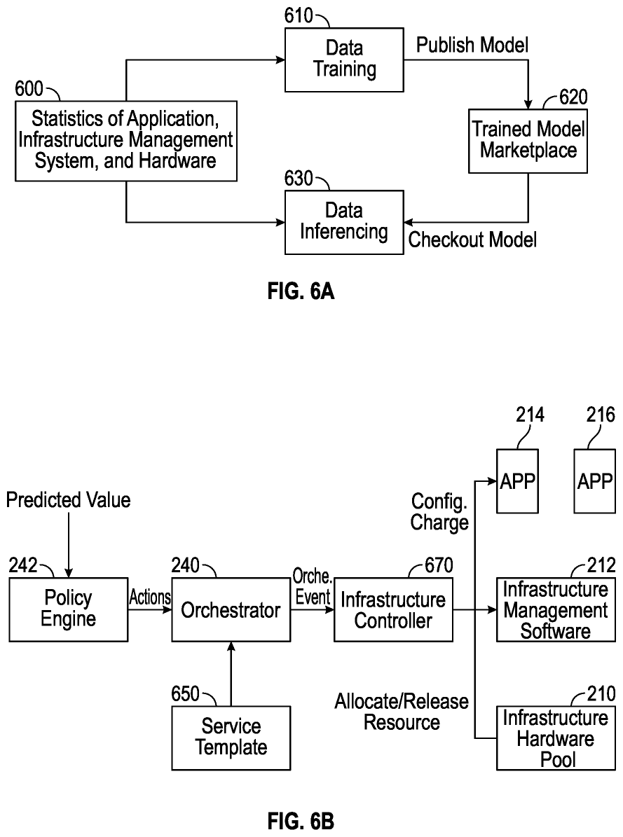

FIG. 6A illustrates the process flow between the data analytics system 222 and the trained model 230 to produce and updated the machine learning model. The telemetry system 220 collects a set of statistical data 600 from the allocated hardware from the hardware pools 210, infrastructure management software 212, and the applications 214 and 216 in FIG. 2. After collection, the telemetry system 220 sends the collected statistical data to the data analytics module 222. The data analytics module 222 conducts training (610) for several kinds of models to predict the statuses of application and infrastructure based on the collected data. The collected data consists of a large amount of data. The obtained data for prediction thus can be divided into several subsets of data, which are not necessarily related, for training different models.

The same collected data can be used for training the different models so as to generate several different trained models. In this example, the output of the models is the throughput of a 10-minute predictive matrix including throughput and packet count. Alternatively, after a model is established as sufficiently robust, the data analytics module 222 will continue to train the established model with received data to further refine the model. The trained models are periodically published to a trained model marketplace 620 that includes multiple different models. Established models are stored in a trained model marketplace 620.

For example, when any inference tasks are required, a data inference engine 630 selects a model from the model marketplace 620 and then inputs the data into the selected model to generate the interference. For example, if it is desired to determine the traffic growth trend in the future for the system 100, the inference engine 630 can check out a related model from the model marketplace 620 and then input the statistical data and timestamp. The inference engine 630 returns the predicted value of a designated time period according to the output of the selected model for traffic growth. The time interval can be any suitable period such as 10 seconds, 10 minutes, or 24 hours. The prediction is output in the form of a matrix of throughput, packet count, and session count values.

FIG. 6B is a system flow of the example orchestration system 240. The policy engine 242 receives a predicted status from the data analytics module 222 based on the output of the trained model in FIG. 2. The policy engine 242 can determine the action of allocation of resources by using a designed rule engine. The rule engines may be predefined by the operator for what designating the allocation of resources in a particular situation. For example, one rule may be for launching new virtual machines or containers on the OCP/OSP environment for a scale-out system.

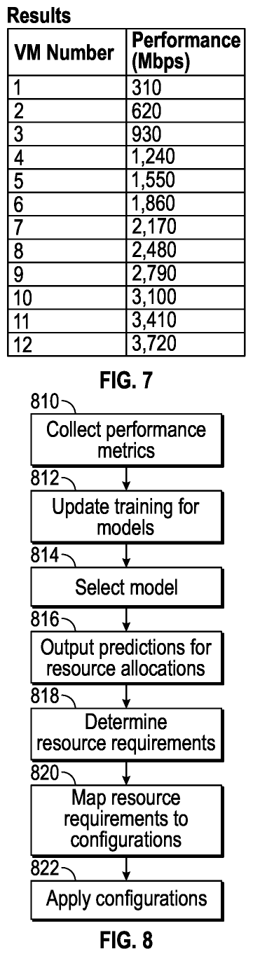

FIG. 7 shows an example table for generating a rule engine. In this example, the number of virtual machines (VMx) is correlated with overall performance in Mbps. In this example, the system is a Linux VM on OSP 13 environment without Peripheral Component Interconnect (PCI) pass through and Single Root I/O Virtualization (SRIOV). The system includes a Xeon 6152 @ 2.1 GHz processor and a 10 Gb backend network. The table in FIG. 7 could therefore be used to determine the number of virtual machines and corresponding hardware resources required for a particular desired performance.

Returning to FIG. 6B, the orchestrator 240 and service template 650 include pre-selected configurations based on resource requirements translated from the predicted future operational data value generated by the data analytics module 222. For example, one configuration may be one system instance handling 100G of resources. Thus, if a current situation requires 100G of resources, and the prediction operational data value for the next 10 minutes is a total throughput of 200G, then one instance needs to be scaled out. If the prediction is 400G, three instances need to be scaled out. If the orchestrator 240 and service template 650 determine that the configuration of allocation of resources should be changed based on the output of the rules engine, the policy engine 242 delivers the actions based on the output action from the rules engine to the orchestrator 240. The orchestrator 240 contains a series of different service templates 650 from the policy engine 242. In this case, there are eight pre-loaded templates having three types of parameters: a) a data-processing module/data-control module; b) a K8s/OpenStack; and c) a scale-out or scale-in designation. Each of the service templates 650 is designed for mapping the operations event to respond to the action. For example, one of these templates may be designated a scale out with data processing module of a Target VNF with a 5G Core; and a Target NFVI as the OpenStack qct.osp.qct.io. The orchestration event with the selected service template is sent to an infrastructure controller 670 that may run on the management station 140 in FIG. 1 for a real configuration change process that is performed on the hardware resources in the infrastructure hardware pool 210 in FIG. 2.

The infrastructure controller 670 contains several kinds of applications, the infrastructure management software 212, and a set of hardware configuration abstraction APIs. When receiving the event, the infrastructure controller 620 translates related commands. The infrastructure controller 620 then sends the translated commands to the physical hardware in the hardware pools 210, the infrastructure management software 212, or the applications 214 and 216 through an appropriate communication protocol. For example, if the target of the translated commands is a hardware component, hardware management interfaces like Redfish and IPMI may be used to send the management commands. If the target of the translated commands is the infrastructure management software 212, the predefined management API of the infrastructure management software 212 can be called to execute the specific management command. If the target of the translated commands is an application, the application API can be executed to run the application-specific configuration changes.

FIG. 8 is a flow diagram of the process of determining distribution for hardware resources in a computing system. The flow diagram in FIG. 8 is representative of example machine readable instructions for the distribution of hardware resources in the system 100 in FIG. 1. In this example, the machine readable instructions comprise an algorithm for execution by: (a) a processor; (b) a controller; and/or (c) one or more other suitable processing device(s). The algorithm may be embodied in software stored on tangible media such as flash memory, CD-ROM, floppy disk, hard drive, digital video (versatile) disk (DVD), or other memory devices. However, persons of ordinary skill in the art will readily appreciate that the entire algorithm and/or parts thereof can alternatively be executed by a device other than a processor and/or embodied in firmware or dedicated hardware in a well-known manner (e.g., it may be implemented by an application specific integrated circuit [ASIC], a programmable logic device [PLD], a field programmable logic device [FPLD], a field programmable gate array [FPGA], discrete logic, etc.). For example, any or all of the components of the interfaces can be implemented by software, hardware, and/or firmware. Also, some or all of the machine readable instructions represented by the flowcharts may be implemented manually. Further, although the example algorithm is described with reference to the flowcharts illustrated in FIG. 8, persons of ordinary skill in the art will readily appreciate that many other methods of implementing the example machine readable instructions may alternatively be used. For example, the order of execution of the blocks may be changed, and/or some of the blocks described may be changed, eliminated, or combined.

The routine is implemented when the infrastructure controller 620 in FIG. 6 requests a hardware resource from the hardware pool 210 via the infrastructure management software 212 in FIG. 2. The routine first activates the data collector in the telemetry system 220 in FIG. 2 to collects performance metrics from hardware in the hardware pool 210, the infrastructure management software 212, and the applications 214 and 216 (810). The performance metrics are sent to the data analytics system 222 to update the training of the models (812). The data analytics system selects a trained model based on operating environment or other factors (814).

The policy engine 242 receives a predicted metric (such as 100G or 200G traffic after 10 minutes) required from the selected model (816). The policy engine 242 then determines the actions required to meet the predicted metric from the predictions and sends the actions to the orchestrator 240 (818). The orchestrator 240 then maps pre-selected configurations to the predicted resource requirements by accessing the appropriate service templates (820). The resulting configurations are applied to the resources of the system (822) In this example the actions are high-level commends. The actions include scaling in and scaling out resources. In this example, a new server in the hardware pool may be made available and Kubernetes or OpenStack may be deployed. A VM or a container may then be deployed and launched in the newly allocated new server hardware.

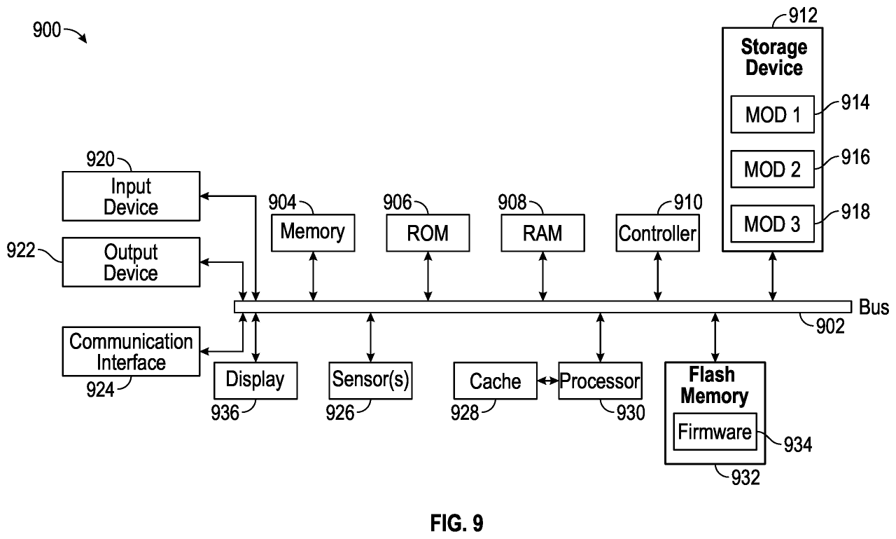

FIG. 9 illustrates an example computing system 900, in which the components of the computing system are in electrical communication with each other using a bus 902. The system 900 includes a processing unit (CPU or processor) 930; and a system bus 902 that couples various system components, including the system memory 904 (e.g., read only memory (ROM) 906 and random access memory (RAM) 908), to the processor 930. The system 900 can include a cache of high-speed memory connected directly with, in close proximity to, or integrated as part of the processor 930. The system 900 can copy data from the memory 904 and/or the storage device 912 to the cache 928 for quick access by the processor 930. In this way, the cache can provide a performance boost for processor 930 while waiting for data. These and other modules can control or be configured to control the processor 930 to perform various actions. Other system memory 804 may be available for use as well. The memory 904 can include multiple different types of memory with different performance characteristics. The processor 930 can include any general purpose processor and a hardware module or software module, such as module 1 914, module 2 916, and module 3 918 embedded in storage device 912. The hardware module or software module is configured to control the processor 930, as well as a special-purpose processor where software instructions are incorporated into the actual processor design. The processor 930 may essentially be a completely self-contained computing system that contains multiple cores or processors, a bus, memory controller, cache, etc. A multi-core processor may be symmetric or asymmetric.

To enable user interaction with the computing device 900, an input device 920 is provided as an input mechanism. The input device 920 can comprise a microphone for speech, a touch-sensitive screen for gesture or graphical input, keyboard, mouse, motion input, and so forth. In some instances, multimodal systems can enable a user to provide multiple types of input to communicate with the system 900. In this example, an output device 922 is also provided. The communications interface 924 can govern and manage the user input and system output.

Storage device 912 can be a non-volatile memory to store data that is accessible by a computer. The storage device 912 can be magnetic cassettes, flash memory cards, solid state memory devices, digital versatile disks, cartridges, random access memories (RAMs) 908, read only memory (ROM) 906, and hybrids thereof.

The controller 910 can be a specialized microcontroller or processor on the system 900, such as a BMC (baseboard management controller). In some cases, the controller 910 can be part of an Intelligent Platform Management Interface (IPMI). Moreover, in some cases, the controller 910 can be embedded on a motherboard or main circuit board of the system 900. The controller 910 can manage the interface between system management software and platform hardware. The controller 910 can also communicate with various system devices and components (internal and/or external), such as controllers or peripheral components, as further described below.

The controller 910 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 910 to initiate or conduct specific hardware recovery procedures or operations, as further described below.

The controller 910 can also include a system event log controller and/or storage for managing and maintaining events, alerts, and notifications received by the controller 910. For example, the controller 910 or a system event log controller can receive alerts or notifications from one or more devices and components, and maintain the alerts or notifications in a system event log storage component.

Flash memory 932 can be an electronic non-volatile computer storage medium or chip that can be used by the system 900 for storage and/or data transfer. The flash memory 932 can be electrically erased and/or reprogrammed. Flash memory 932 can include EPROM (erasable programmable read-only memory), EEPROM (electrically erasable programmable read-only memory), ROM, NVRAM, or CMOS (complementary metal-oxide semiconductor), for example. The flash memory 932 can store the firmware 934 executed by the system 900 when the system 900 is first powered on, along with a set of configurations specified for the firmware 934. The flash memory 932 can also store configurations used by the firmware 934.

The firmware 934 can include a Basic Input/Output System or equivalents, such as an EFI (Extensible Firmware Interface) or UEFI (Unified Extensible Firmware Interface). The firmware 934 can be loaded and executed as a sequence program each time the system 900 is started. The firmware 934 can recognize, initialize, and test hardware present in the system 800 based on the set of configurations. The firmware 934 can perform a self-test, such as a POST (Power-On-Self-Test), on the system 900. This self-test can test the functionality of various hardware components such as hard disk drives, optical reading devices, cooling devices, memory modules, expansion cards, and the like. The firmware 934 can address and allocate an area in the memory 904, ROM 906, RAM 908, and/or storage device 912, to store an operating system (OS). The firmware 834 can load a boot loader and/or OS, and give control of the system 900 to the OS.

The firmware 934 of the system 900 can include a firmware configuration that defines how the firmware 934 controls various hardware components in the system 900. The firmware configuration can determine the order in which the various hardware components in the system 900 are started. The firmware 934 can provide an interface, such as an UEFI, that allows a variety of different parameters to be set, which can be different from parameters in a firmware default configuration. For example, a user (e.g., an administrator) can use the firmware 934 to specify clock and bus speeds; define what peripherals are attached to the system 900; set monitoring of health (e.g., fan speeds and CPU temperature limits); and/or provide a variety of other parameters that affect overall performance and power usage of the system 900. While firmware 934 is illustrated as being stored in the flash memory 932, one of ordinary skill in the art will readily recognize that the firmware 934 can be stored in other memory components, such as memory 904 or ROM 906.

System 900 can include one or more sensors 926. The one or more sensors 926 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 926 can communicate with the processor, cache 928, flash memory 932, communications interface 924, memory 904, ROM 906, RAM 908, controller 910, and storage device 912, via the bus 902, for example. The one or more sensors 926 can also communicate with other components in the system via one or more different means, such as inter-integrated circuit (I2C), general purpose input output (GPIO), and the like. Different types of sensors (e.g., sensors 926) on the system 900 can also report to the controller 910 on parameters, such as cooling fan speeds, power status, operating system (OS) status, hardware status, and so forth. A display 936 may be used by the system 900 to provide graphics related to the applications that are executed by the controller 910.

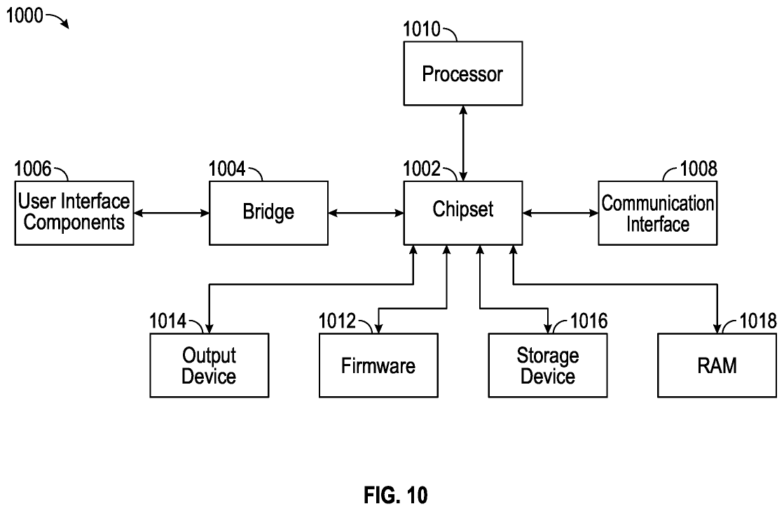

FIG. 10 illustrates an example computer system 1000 having a chipset architecture that can be used in executing the described method(s) or operations, and generating and displaying a graphical user interface (GUI). Computer system 1000 can include computer hardware, software, and firmware that can be used to implement the disclosed technology. System 1000 can include a processor 1010, representative of a variety of physically and/or logically distinct resources capable of executing software, firmware, and hardware configured to perform identified computations. Processor 1010 can communicate with a chipset 1002 that can control input to and output from processor 1010. In this example, chipset 1002 outputs information to output device 1014, such as a display, and can read and write information to storage device 1016. The storage device 1016 can include magnetic media, and solid state media, for example. Chipset 1002 can also read data from and write data to RAM 1018. A bridge 1004 for interfacing with a variety of user interface components 1006, can be provided for interfacing with chipset 1002. User interface components 1006 can include a keyboard, a microphone, touch detection and processing circuitry, and a pointing device, such as a mouse.

Chipset 1002 can also interface with one or more communication interfaces 1008 that can have different physical interfaces. Such communication interfaces can include interfaces for wired and wireless local area networks, for broadband wireless networks, and for personal area networks. Further, the machine can receive inputs from a user via user interface components 1006, and execute appropriate functions, such as browsing functions by interpreting these inputs using processor 1010.

Moreover, chipset 1002 can also communicate with firmware 1012, which can be executed by the computer system 1000 when powering on. The firmware 1012 can recognize, initialize, and test hardware present in the computer system 1000 based on a set of firmware configurations. The firmware 1012 can perform a self-test, such as a POST, on the system 1000. The self-test can test the functionality of the various hardware components 1002-1018. The firmware 1012 can address and allocate an area in the memory 1018 to store an OS. The firmware 1012 can load a boot loader and/or OS, and give control of the system 1000 to the OS. In some cases, the firmware 1012 can communicate with the hardware components 1002-1010 and 1014-1018. Here, the firmware 1012 can communicate with the hardware components 1002-1010 and 1014-1018 through the chipset 1002, and/or through one or more other components. In some cases, the firmware 1012 can communicate directly with the hardware components 1002-10710 and 1014-1018.

It can be appreciated that example systems 900 (in FIG. 9) and 1000 can have more than one processor (e.g., 930, 1010), or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A system for distributing resources in a computing system, the resources including at least one of a hardware component, a management infrastructure, or an application, the system comprising:
a telemetry system coupled to the resources to collect operational data from the operation of the resources;
a data analytics system coupled to the telemetry subsystem to predict a future operational data value based on the collected operational data; and
a policy engine coupled to the data analytics system to determine a configuration change action for the allocation of the resources in response to the predicted future operational data value.

2. The system of claim 1, wherein the data analytics system determines the future operational data value based on a machine learning system, wherein the operational data collected by the telemetry subsystem trains the machine learning system.

3. The system of claim 2, wherein the machine learning system produces multiple models, wherein each of the multiple models predict a different scenario of the future operational data value.

4. The system of claim 3, wherein the data analytics system selects one of the multiple models to determine the resource allocation.

5. The system of claim 1, wherein the policy engine includes a template to translate the predicted future operational data value from the data analytics system into the resource allocation.

6. The system of claim 5, wherein the configurations include a hardware management interface for the hardware component, a management API for the infrastructure and an application API for the application.

7. The system of claim 1, wherein the hardware component is one of a group of processors, management controllers, storage devices, and network interface cards.

8. The system of claim 1, wherein the resources are directed toward the execution of the application.

9. The system of claim 1, wherein the hardware components are deployed in computer servers organized in racks.

10. The system of claim 1, wherein the future operational data value is a computational requirement at a predetermined time.

11. A method of allocating resources in a computing system, the resources including at least one of a hardware component, a management infrastructure, or an application, the method comprising:
collecting operational data from the operation of the resources via a telemetry system;
predicting a future operational data value based on the collected operational data via a data analytics system; and
determining a configuration to allocate the resources in response to the predicted future operational data value.

12. The method of claim 10, further comprising training a machine learning system from the collected data, and wherein the data analytics system determines the future operational data value from the machine learning system.

13. The method of claim 11, further comprising producing multiple models from the machine learning system, wherein each of the multiple models predict a different scenario of the future operational data value.

14. The method of claim 12, wherein the data analytics system selects one of the multiple models to determine the resource allocation.

15. The method of claim 10, wherein the policy engine includes a template to translate the predicted future operational data value from the data analytics system into the resource allocation.

16. The method of claim 15, wherein the configurations include a hardware management interface for the hardware component, a management API for the infrastructure and an application API for the application.

17. The method of claim 11, wherein the hardware component is one of a group of processors, management controllers, storage devices, and network interface cards.

18. The method of claim 11, wherein the resources are directed toward the execution of the application.

19. The method of claim 11, wherein the hardware components are deployed in computer servers organized in racks.

20. The method of claim 11, wherein the future operational data value is a computational requirement at a predetermined time.
